(19) United States
(12) Patent Application Publication
(10) Pub. No.: US 2020/0334316 A1
(43) Pub. Date: Oct. 22, 2020

(54) DIGITAL CONTENT ITEM ASSOCIATED WITH A USER CHARACTERISTIC

(71) Applicant: Hewlett-Packard Development Company, L.P., Houston, TX (US)

(72) Inventors: Lucio Polese Cossio, Porto Alegre (BR); Fernanda Maira Gallina, Porto Alegre (BR); Renato Oliveria da Silva, Porto Alegre (BR)

(21) Appl. No.: 16/095,748

(22) PCT Filed: Jul. 1, 2016
(86) PCT No.: PCT/US2016/040679

§ 371 Date: Oct. 23, 2018

(51) Int. Cl. G06F 16/955; G06F 16/9535; G06K 7/14

(52) U.S. Cl. CPC G06F 16/9554; G06Q 30/0257; G06K 7/1408; G06F 16/9535

(57) ABSTRACT

In some examples, a system receives a request for digital content that is responsive to a capture of an image of a mark, receives information relating to a captured image of a user, and in response to the request, identifies, from a plurality of different digital content items associated with the mark, a first digital content item, the first digital content item identified responsive to a characteristic of the user determined based on the captured image of the user, and the plurality of digital content items associated with respective different characteristics of users. The system communicates the identified first digital content item to output, by an output device, information based on the identified first digital content item.

### BACKGROUND

A mark can be used to trigger access of digital content. Examples such marks can include a barcode, a quick response (QR) code (which is a two-dimensional barcode), a watermark, or a logo. An electronic device can be used to capture an image of a mark, which can be printed on a print medium or displayed by a display device. The capture of an image of the mark triggers the sending of a request to access a respective digital content.

### BRIEF DESCRIPTION OF THE DRAWINGS

Some implementations of the present disclosure are described with respect to the following figures.

FIG. 1 is a block diagram of an arrangement that allows for access of personalized digital content, in accordance with some examples.

FIG. 2 is a block diagram of a storage medium storing machine-readable instructions to obtain personalized digital content according to some examples.

FIGS. 3 and 4 are block diagrams of electronic devices according to some examples.

FIG. 5 is a flow diagram of a process of adding a mark and associating digital content items with the mark and corresponding characteristics of users, according to some examples.

FIG. 6 is a block diagram of a graphical user interface screen to allow for user addition of a mark and association of the mark with respective different digital content corresponding to different characteristics of users, according to some examples.

### DETAILED DESCRIPTION

An electronic device can be used to capture an image of a mark that is designated for triggering access of a respective digital content. A “digital content” can refer to information that can be presented to a user relating to a product, a service, or any other item. The information in the digital content can include text, graphical images, audio data, video data, and so forth. The “digital content” can alternatively refer to locator information that can be used to retrieve or access information that can be presented, such as text, graphical images, audio data, video data, and so forth. The locator information can be in the form of a uniform resource locator (URL), or information of another format that specifies a path to other information, or action(s) to take to access the other information.

The mark can be in the form of a barcode, a quick response (QR) code (which is a two-dimensional barcode), a watermark, a logo, or any other indicator that is associated with a respective digital content. A watermark is an indicator provided to cause further content to be retrieved. A logo can be used to identify a manufacturer or source of a product or service.

A mark can be printed on a print medium, such as on a page of a magazine or newspaper, on a poster, or on any other type of substrate onto which a printing fluid (such as ink) can be applied to print text and graphics. Alternatively, the mark can be displayed by a display device, such as a television, a computer display monitor, and so forth.

The electronic device can include an image sensor (e.g., a camera) that can acquire a visual representation (e.g., a still image or video) of a target object. In response to a capture of an image of a mark, information from the mark (such as a barcode or QR code) can be extracted to cause the electronic device to retrieve respective digital content. Alternatively, in examples where the mark is a watermark or a logo, the mark can be recognized by an image processing technique—the recognition of the mark triggers the electronic device to obtain the respective digital content.

In response to detection of the mark in the captured image, the electronic device can send a request to a remote location (e.g., a server) to access the respective digital content. In some examples, the digital content that is associated with the mark is a generic digital content that is provided regardless of the audience of the digital content. For example, the same digital content is returned in response to the request regardless of whether a user is male or female, or regardless of the age of the user. As a result, the returned digital content is not personalized to the requesting user, which may reduce the effectiveness or relevance of the digital content.

In accordance with some implementations of the present disclosure, personalized, different digital content can be retrieved in response to an image capture of a mark for respective different user groups. A “user group” can refer to a category of users that is defined by a respective characteristic of the users. In some examples, a characteristic of a user can refer to any or some combination of the following: gender, age, race, and so forth. To personalize the digital content for different user groups, characteristics of users can be determined based on captured images of the users. A determined characteristic can be used to select from among different digital content items to return to a requesting user in response to an image capture of a mark.

In further implementations of the present disclosure, a technique or system can be provided to allow for addition of a mark that is useable to trigger access of digital content, and to associate different content items that correspond to different characteristics of users with the mark.

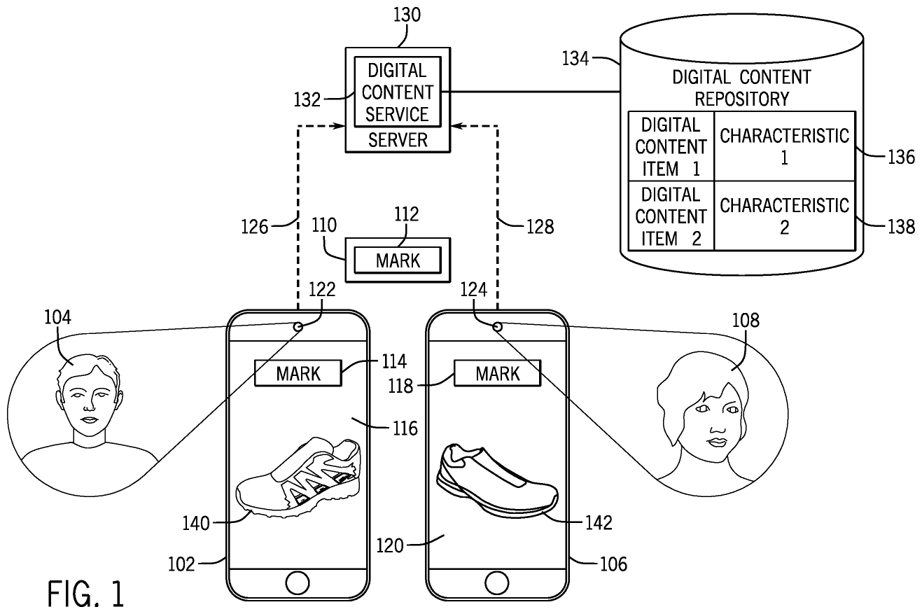

FIG. 1 illustrates an example arrangement that includes a first electronic device 102 used by a first user 104, and a second electronic device 106 used by a second user 108. The electronic devices 102 and 106 can include any of the following: smartphones, tablet computers, notebook computers, desktop computers, game appliances, wearable devices (e.g., smart watches, smart eyeglasses, etc.), and so forth. In the example of FIG. 1, the first user 104 is a male, while the second user 108 is a female.

FIG. 1 also shows a print medium 110 on which is printed a mark 112.

Although one print medium 110 with the mark 112 is shown in FIG. 1, it is noted that multiple copies of the print medium 110 can be provided, where the electronic devices 102 and 106 can be used to capture images of the mark 112 on the copies of the print medium 110. In other examples, the mark 112 can be displayed by a display device (or by multiple display devices). The mark 112 displayed by a display device can also be captured by the electronic device 102 or 106.

The electronic device 102 includes a camera to capture the mark 112 on the print medium 110, and the electronic device 106 similarly includes a camera to capture the mark 112 on the print medium 110 (or another copy of the print medium 110). As shown in FIG. 1, an image 114 of the mark can be displayed by a display 116 of the first electronic device 102, and an image 118 of the mark 112 can be displayed by a display 120 of the second electronic device 106. In other examples, the images 114 and 118 of the mark 112 are not displayed by the displays 116 and 120, respectively.

In some examples, the camera that is used to capture the mark 112 is a first camera of the electronic device 102 or 106. This first camera can be a rear camera on a rear portion of the electronic device 102 or 106, where the rear portion is the portion of the electronic device that is opposite of the front portion of the electronic device 102 or 106 that the user faces when looking at the respective display 116 or 120.

Each electronic device 102 or 106 can include a respective second camera 122 or 124, where the second camera can be a front camera that is on the front portion of the electronic device 102 or 106. The front camera 122 or 124 can be used to capture an image of the respective first user 104 or 108.

In other examples, the electronic device 102 or 106 can include just one camera that can be used to capture the mark 112 and the corresponding user.

The image capture of the mark 112 by either the electronic device 102 or 106 triggers the electronic device 102 or 106 to send (at 126 or 128, respectively) a request to retrieve digital content corresponding to the mark from a server 130. The request that is sent from the electronic device 102 or 106 to the server 130 can be sent over a network, such as the Internet, a local area network, and so forth. The network can be a wired network or a wireless network.

Each electronic device 102 or 106 includes logic (e.g., a hardware processing circuit or a combination of machine-readable instructions and the hardware processing circuit) to determine a characteristic of a user based on a captured image of the user. In some examples, the identified characteristic (e.g., age, gender, and/or race) of the user can be included in the request sent at 126 or 128 to the server 130. Alternatively, in further examples, the characteristic of the user can be sent separately from the request, either before or after the request has been sent to the server 130.

In the example of FIG. 1, the user characteristic sent by the first electronic device 102 in conjunction with the request sent at 126 identifies a male user, and the user characteristic sent by the second electronic device 106 in conjunction with the request sent at 128 identifies a female user.

The server 130, which can be implemented as a computer system or a collection of computer systems, includes a digital content service 132 executable in the server 130. The digital content service 132 is able to selectively select a digital content item, from among multiple digital content items that correspond to the mark 112, based on the characteristic of the user sent by the electronic device 102 or 106 to the server 130. A digital content item (in the form of a file, a document, or any other collection of information) can include information that can be presented (e.g., displayed or played as an audio) at a requesting electronic device 102 or 106. Alternatively, the digital content item can include locator information that can be used to retrieve or access information to be presented.

In some examples, the digital content items corresponding to the mark 112 can be stored in a digital content repository 134. In the example shown in FIG. 1, the digital content repository 134 includes a first entry 136 that stores digital content item 1 associated with a first characteristic, and a second entry 138 that stores digital content item 2 associated with a second characteristic that is different from the first characteristic. The digital content repository 134 can include further entries storing additional digital content items associated with other characteristics of users. Generally, the multiple digital content items in the digital content repository 134 correspond to different characteristics of the users.

In response to a request for digital content triggered by an image capture of the mark 112, the digital content service 132 can select one of the digital content items from the digital content repository, where the selecting is based on the characteristic of the requesting user.

The digital content service 132 returns the selected digital content item back to the electronic device 102 or 106 that submitted the request. In some examples, the digital content associated with the mark 112 can include information relating to jogging shoes. Digital content item 1 can be associated with a first characteristic of a user, e.g., a male user. Thus, digital content item 1 can include information relating to men's jogging shoes, which is returned by the digital content service 132 to the first electronic device 102 in response to the request sent at 126. Digital content item 2 can be associated with a second characteristic of a user, e.g., a female user. Thus, digital content item 2 can include information relating to women's jogging shoes, which is returned by the digital content service 132 to the second electronic device 106 in response to the request sent at 128.

In the example of FIG. 1, an image (or other information) 140 of men's running shoes is shown in the display 116 of the first electronic device 102, while an image (or other information) 142 of women's running shoes is displayed in the display 120 of the second electronic device 106.

The digital content service 132 can be implemented as machine-readable instructions executable by a processor (or multiple processors) of the server 130. A processor can refer to a microprocessor, a core of a multi-core microprocessor, a microcontroller, a programmable gate array, or a programmable integrated circuit device, or a combination of the foregoing, or any other hardware processing circuit.

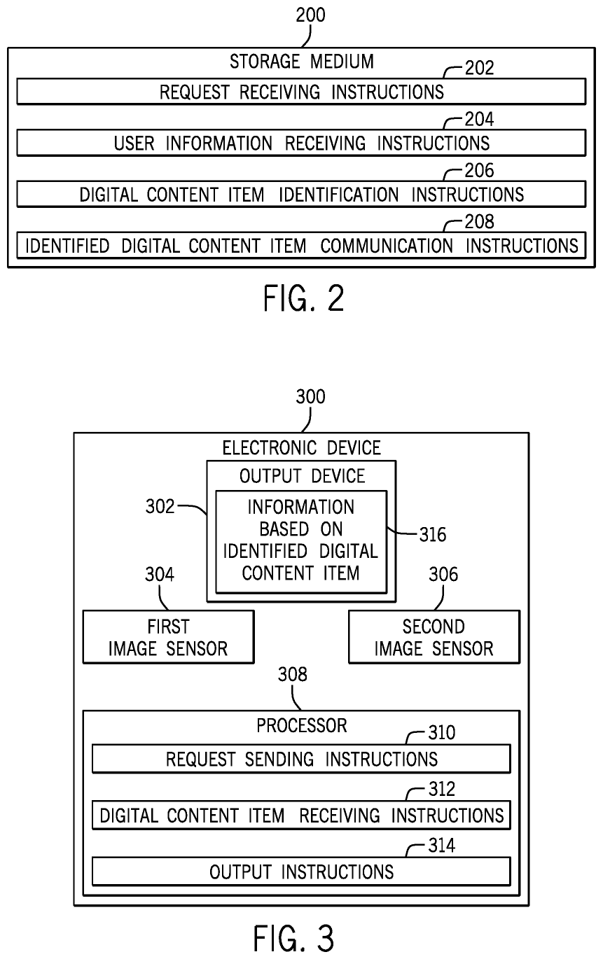

As shown in FIG. 2, the machine-readable instructions of the digital content service 132 can be stored in a non-transitory machine-readable or computer-readable storage medium 200.

The machine-readable instructions include request receiving instructions 202 to receive a request (sent by an electronic device) for digital content that is responsive to a capture of an image of a mark, such as the mark 112 of FIG. 1. The machine-readable instructions further include user information receiving instructions 204 to receive information relating to a captured image of a user, such as the user 104 or 108 in FIG. 1. The information relating to the captured image of the user can be included in the request, or can be separate from the request (in which case the information relating to the captured image of a user can be received either before or after the request is received). In some examples, the information relating to the captured image of the user is a characteristic of the user determined based on the captured image of the user. In other examples, the information relating to the captured image of the user can be the captured image itself, which can be processed by the digital content service 132 to determine the characteristic of the user. Thus, in some implementations, the determination of the characteristic of the user based on the captured image of the user can be performed at an electronic device (e.g., the electronic device 102 or 106) associated with the user. In other examples, the determination of the characteristic of the user based on the captured image of the user can be performed by the digital content service 132, or by another application invoked by the digital content service 132.

The machine-readable instructions further include digital content item identification instructions 206 to, in response to the request received from the electronic device, identify, from multiple different digital content items associated with the mark, a digital content item, where the digital content item is identified responsive to the characteristic of the user. For example, the digital content item identification instructions 206 can select one of the digital content items in the digital content repository 134 of FIG. 1, based on the characteristic of the user.

The machine-readable instructions further include identified digital content item communication instructions 208 to communicate the identified digital content item to output, by an output device, information based on the identified digital content item. For example, the identified digital content item communication instructions 208 can cause the identified digital content item to be transmitted by the server 130 to the electronic device 102 or 106, which includes the display 116 or 120, respectively (the display is an example of an output device), to display information based on the identified digital content item. In other examples, the output device can include an audio output device to play audio information based on the identified digital content item. Information based on the identified digital content item can include the digital content item itself that can be presented (displayed or played audibly). Alternatively, the information based on the identified digital content item can be information retrieved or accessed using locator information in the identified digital content item.

FIG. 3 is a block diagram of an example electronic device 300, which can be electronic device 102 or 106 of FIG. 1, for example. The electronic device 300 includes an output device 302, which can be a display device and/or an audio output device. The electronic device 300 further includes a first image sensor 304 and a second image sensor 306. In some examples, the first image sensor 304 can be a rear image sensor on the rear portion of the electronic device 300, while the second image sensor 306 can be a front image sensor on a front portion of the electronic device 300. The first image sensor 304 can be used to capture a mark, such as the mark 112 shown in FIG. 1. The second image sensor 306 can be used to capture an image of a user of the electronic device 300.

In some examples, the capture of an image of the mark by the first image sensor 304 can trigger the second image sensor 306 to capture the image of the user. In other examples, the second image sensor 306 can be used to capture the image of the user independently of the image capture of the mark by the first image sensor 304. The captured image of the user, or a characteristic determined based on the captured image of the user, can be stored and accessed at a later time to submit in conjunction with a request for digital content responsive to image capture of the mark.

Although reference is made to using two image sensors to capture, respectively, images of a mark and a user, it is noted that in other examples, just one image sensor of the electronic device 300 can be used to capture both the image of a mark and the image of a user. For example, the image sensor can be used to first capture the image of the user, followed by the capture of the image of the mark, or vice versa.

The electronic device 300 also includes a processor 308 (or multiple processors) that execute(s) machine-readable instructions. For example, the machine-readable instructions that can be executed by the processor(s) 308 include request sending instructions 310 to send, to a server (e.g., the server 130 in FIG. 1), a request for digital content responsive to a captured image of a mark. The request can include information relating to the captured image of the user. The machine-readable instructions further include digital content item receiving instructions 312 to receive, from the server over a network, an identified digital content item, where the identified digital content item corresponds to a characteristic of the user determined from the captured image of the user, and the identified digital content item is selected from multiple digital content items that correspond to respective different characteristics of users. The machine-readable instructions further include output instructions 314 to cause output of information based on the received identified digital content item on the output device 302. In the example of FIG. 3, information based on an identified digital content item (316) is output by the output device 302.

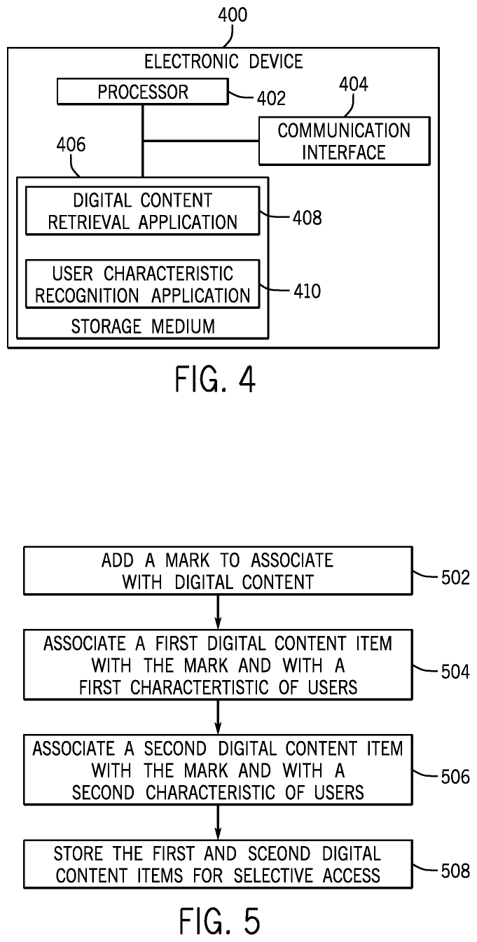

FIG. 4 depicts an electronic device 400, which in some examples can be the electronic device 102 or 106 shown in FIG. 1. The electronic device 400 includes a processor (or multiple processors) 402, which is coupled to a communication interface 404 (to allow the electronic device 400 to communicate over a network), and a non-transitory machine-readable or computer-readable storage medium 406. The storage medium 406 stores a digital content retrieval application 408 and a user characteristic recognition application 410. The digital content retrieval application 408 can perform the retrieval of digital content in response to capturing an image of a mark and an image of a characteristic determined from a captured image of the user. For example, the digital content retrieval application 408 can include the machine-readable instructions 310, 312, and 314 shown in FIG. 3.

The user characteristic recognition application 410 can determine a characteristic of a user based on a captured image of the user. The user characteristic recognition application 410 can analyze an image of a user to find a face of the user in the image. Based on features in the face, a characteristic of the user can be determined by the user characteristic recognition application. The user characteristic recognition application 410 can be an off-the-shelf application that can be used to perform recognition of a user's race, gender, or age, in some examples. Alternatively, the user characteristic recognition application 410 can be a customized application to perform a determination of a characteristic of a user. For example, analysis of a skin color of the user can be used to predict a race of the user. Alternatively, features on the face of the user in the captured image can be compared to a database of features to predict an age of the user and/or a gender of the user.

In further implementations, FIG. 5 shows an example process of registering a mark with respective different digital content items for different user characteristics. The process of FIG. 5 can be performed by computer system, which can be separate from server 130 of FIG. 1, or part of the server 130 of FIG. 1.

The process of FIG. 5 adds (at 502) a mark to associate with digital content. For example, a user can select a mark to use for triggering retrieval of digital content. The process of FIG. 5 further includes associating (at 504) a first digital content item with the mark and with a first characteristic of users, and associating (at 506) a second digital content item with the mark and with a second, different characteristic of users. The process of FIG. 5 further includes storing (at 508) the first and second digital content items (such as in the digital content repository 134 of FIG. 1) for selective access in response to capture of an image of the mark and a characteristic of a user determined based on a captured image of the user.

Although FIG. 5 refers to associating first and second digital content items with respective first and second user characteristics, it is noted that in other examples, additional digital content items can be associated with other user characteristics.

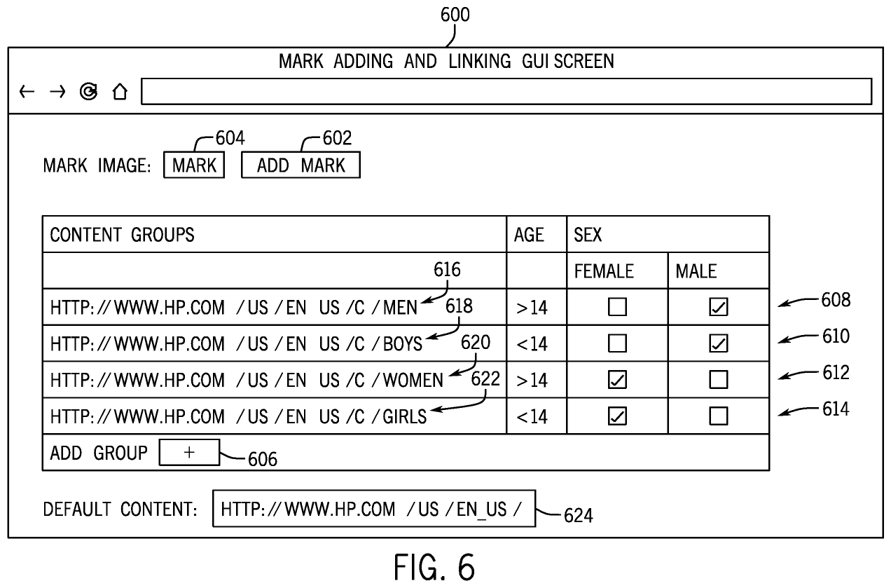

FIG. 6 shows a graphical user interface (GUI) screen 600 that can be used as part of the process of FIG. 5. The GUI screen 600 includes an “Add Mark” button 602, which can be a user-selectable button displayed in the GUI screen 600. In response to user selection of the “Add Mark” button 602, a list of candidate marks can be presented to a user. The user can select one of the candidate marks as the mark to add. The selected mark is displayed as a mark image 604. In other examples, instead of selecting a mark to add from a list of candidate marks, a user can add the mark in a different manner, such as by importing a mark image from a storage location.

The GUI screen 600 further includes an “Add Group” control button 606, to allow a user to add a content group. In the example of FIG. 6, the GUI screen 600 depicts four content groups, including a first content group 608 for men, a second content group 610 for boys, a third content group 612 for women, and a fourth content group 614 for girls. A “content group” refers to a category of digital content to be associated with a respective user characteristic.

The content groups 608, 610, 612, and 614 are associated with respective locators 616, 618, 620, and 622 that refer to respective digital content items for the respective different characteristics of users. For example, the locator 616 refers to a digital content item for men, the locator 618 refers to a digital content item for boys, the locator 620 refers to a digital content item for women, and the locator 622 refers to a digital content item for girls. Each locator 616, 618, 620, or 622 can be in the form of a uniform resource locator (URL), or other identifier that is usable to retrieve the respective digital content item.

In some examples, a text field 624 contains a locator for a default digital content item, in case a characteristic of a user cannot be determined with high confidence based on the captured image of the user, or in cases where the captured image of the user is not available for detection.

The storage medium 200 of FIG. 2 or the storage medium 406 of FIG. 4 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium storing instructions that upon execution cause a system to:
receive a request for digital content that is responsive to a capture of an image of a mark;
receive information relating to a captured image of a user;
in response to the request, identify, from a plurality of different digital content items associated with the mark, a first digital content item, the first digital content item identified responsive to a characteristic of the user determined based on the captured image of the user, and the plurality of digital content items associated with respective different characteristics of users; and
communicate the identified first digital content item to output, by an output device, information based on the identified first digital content item.

2. The non-transitory machine-readable storage medium of claim 1, wherein the request is received responsive to the capture of the image of the mark by a first image sensor of an electronic device, and the image of the user is captured by a second image sensor of the electronic device.

3. The non-transitory machine-readable storage medium of claim 2, wherein the first image sensor is a rear camera of the electronic device, and the second image sensor is a front camera of the electronic device.

4. The non-transitory machine-readable storage medium of claim 2, wherein the received information relating to the captured image of the user comprises information of the characteristic of the user determined by an electronic device from the captured image of the user.

5. The non-transitory machine-readable storage medium of claim 1, wherein the instructions upon execution cause the system to:
determine, based on processing a face in the captured image of the user, the characteristic of the user.

6. The non-transitory machine-readable storage medium of claim 1, wherein the characteristic of the user is at least one selected from among an age, a gender, or a race.

7. The non-transitory machine-readable storage medium of claim 1, wherein the information relating to the captured image of a user is included in the request.

8. The non-transitory machine-readable storage medium of claim 1, wherein the request is received from an electronic device over a network, and wherein the communicating of the identified first digital content item comprises transmitting, by the system to the electronic device over the network, the identified first digital content.

9. An electronic device comprising:
an output device;
a first image sensor to capture an image of a mark associated with digital content;
a second image sensor to capture an image of a user; and
a processor to:
send, to a server over a network, a request for digital content responsive to the captured image of the mark, the request containing information relating to the captured image of the user,
receive, from the server over the network, an identified digital content item, the identified digital content item corresponding to a characteristic of the user determined from the captured image of the user, and the identified digital content item selected from a plurality of digital content items associated with respective different characteristics of users, and
cause output of information based on the received identified digital content item on the output device.

10. The electronic device of claim 9, wherein the output device comprises a display device to display the information based on the received identified digital content item.

11. The electronic device of claim 9, wherein the processor is to trigger the second image sensor to capture the image of the user responsive to the capture of the mark by the first image sensor.

12. The electronic device of claim 9, further comprising an application executable on the processor to determine the characteristic of the user based on the captured image of the user.

13. The electronic device of claim 9, wherein the mark is printed on a print medium or displayed on a display device.

14. A method comprising:
adding, by a system comprising a processor, a mark to associate with digital content, the mark useable as a trigger to access the digital content;
associating, by the system, a first digital content item with the mark and with a first characteristic of users;
associating, by the system, a second digital content item with the mark and with a second, different characteristic of users; and
storing the first and second digital content items for selective access in response to a capture of an image of the mark and a characteristic of a user determined based on a captured image of the user.

15. The method of claim 14, further comprising outputting the mark for printing on a substrate or display by a display device.
